(19) United States
(12) Patent Application Publication
(10) Pub. No.: US 2024/0316644 A1
(43) Pub. Date: Sep. 26, 2024

(54) ANNEALING APPARATUS AND METHOD USING INDUCED HEATING COIL

(71) Applicant: IUCF-HYU (INDUSTRY-UNIVERSITY COOPERATION FOUNDATION HANYANG UNIVERSITY), Seoul (KR)

(72) Inventors: Seung Hwan LEE, Seoul (KR); Jun Myoung JANG, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 18/290,226

(22) PCT Filed: May 11, 2022
(86) PCT No.: PCT/KR2022/006707

§ 371 Date: Jan. 17, 2024

(30) Foreign Application Priority Data
May 11, 2021 (KR) 10-2021-0060874

(51) Int. Cl. B22F 10/64; B22F 10/28; B33Y 10/00; B33Y 40/20; H05B 6/36

(52) U.S. Cl. CPC B22F 10/64; B22F 10/28; B33Y 10/00; B33Y 40/20; H05B 6/36; B22F 2998/10

(57) ABSTRACT

The present invention relates to a device for heat treatment using an induction heating coil or a method thereof. More particularly, the method of performing heat treatment in real-time at the same time as lamination through an induction heating coil that can move relative to a to-be-heated object when forming a laminated structure includes a melting step of melting a lamination material; a laminating step of laminating a to-be-heated object through the melting step; a heat treatment step of performing heat treatment in real-time using an induction heating coil when a temperature of a first laminated part of the to-be-heated object reaches a heat treatment temperature; and a coil movement step of moving the induction heating coil in a lamination direction to perform a heat treatment step of a second laminated part after the heat treatment of the first laminated part is completed.

### TECHNICAL FIELD

The present invention relates to a device for heat treatment using an induction heating coil and a method thereof, and more particularly to a device capable of performing heat treatment in real-time at the same time as lamination through an induction heating coil that can move relative to a to-be-heated object when forming a laminated structure and a method thereof.

### BACKGROUND ART

There have been difficulties in producing complex shapes using casting or forging processes for manufacturing existing metal products. Meanwhile, additive manufacturing technology receives information from 3D model data and builds it up one layer at a time. By using this additive manufacturing technology, products with shapes that were difficult to manufacture using existing processing methods can be easily manufactured. However, a heat treatment process is essential to remove anisotropy generated during additive manufacturing and prevent deterioration of mechanical properties.

In general, a heat treatment process involves heating an object according to the heat treatment process conditions determined for each of the mechanical properties to be obtained and laminated materials, maintaining it for a specified time, and then cooling it to a low temperature. For example, in the case of solution heat treatment, which is a step in a heat treatment process for precipitation hardening, the process involves heating an object to 950° C.˜1000° C., holding it for up to 30 minutes, and then cooling it. Here, when using a general heating furnace, the heating rate of an object to be heated is 10° C./min on average, which takes 90 minutes, whereas when using induction heating with an induction current frequency of 70 kHz, the heating rate is 600° C./min, which allows the temperature for heat treatment to reach within 2 minutes. In addition, when heat treatment is performed using a conventional heating furnace, there is a problem that it is difficult to insert or remove a product from the heating furnace if the size of the product is large.

Korean Patent No. 10-1367271 (INDUCTION HEATING COIL, HEAT TREATMENT DEVICE AND HEAT TREATMENT METHOD), which is an existing technology of performing heat treatment using induction heating, relates to a technique of inductively heating a to-be-treated portion of a to-be-treated object by relatively moving a heating coil along the circumferential direction of the to-be-treated portion by rotating at least one of the to-be-treated object and the heating coil.

However, the existing technology is characterized by performing a heat treatment process on a finished object and has a problem in that it cannot be applied to an additive manufacturing structure.

### Disclosure

### Technical Problem

Therefore, the present invention has been made in view of the above problems, and it is one object of the present invention to provide a novel form of invention that can dramatically shorten a heat treatment process by performing heat treatment at the same time as lamination in products manufactured through additive manufacturing methods such as welding and 3D printing.

### Technical Solution

In accordance with an aspect of the present invention, the above and other objects can be accomplished by the provision of a device for heat treatment using an induction heating coil, the device including: a supplier for supplying a lamination material; an irradiator for applying heat to melt the lamination material; an induction heating coil, operated at a preset heat treatment temperature, on a laminated part, which requires heat treatment, of a to-be-heated object in which the lamination material is melted and laminated; and a controller configured to turn the induction heating coil on and off or to control the induction heating coil to move in a lamination direction of the to-be-heated object.

Here, the device may further include a thermometer configured to determine whether the laminated part reaches the heat treatment temperature.

In addition, the thermometer may be an infrared thermometer capable of sensing temperature without contacting the laminated part.

Meanwhile, the induction heating coil may maintain the heat treatment temperature for a preset time and then stop operating when a temperature of the laminated part reaches the heat treatment temperature.

According to an embodiment, the induction heating coil may be formed to surround the to-be-heated object.

Here, when the to-be-heated object is laminated to a preset height, lamination may be stopped for heat treatment.

According to another embodiment, the induction heating coil may be formed on one side of the irradiator to face a laminated part melted by the irradiator.

In accordance with another aspect of the present invention, there is provided a heat treatment method using an induction heating coil, the heat treatment method including: a melting step of melting a lamination material; a laminating step of laminating a to-be-heated object through the melting step; a heat treatment step of performing heat treatment in real-time using an induction heating coil when a temperature of a first laminated part of the to-be-heated object reaches a heat treatment temperature; and a coil movement step of moving the induction heating coil in a lamination direction to perform a heat treatment step of a second laminated part after the heat treatment of the first laminated part is completed.

Meanwhile, the heat treatment method may further include a heat treatment control step in which, when a temperature of the first laminated part reaches the heat treatment temperature, the induction heating coil maintains the heat treatment temperature for a preset time and then operation thereof is stopped.

Here, the heat treatment method may further include a cooling step of cooling to a preset cooling temperature after heat treatment of the first laminated part is completed.

According to an embodiment, the induction heating coil may be formed to surround the to-be-heated object.

According to an embodiment, in the laminating step, laminating may be stopped when a height of the first laminated part reaches a preset height.

According to another embodiment, the induction heating coil may be formed to be movable along a laminated part where a lamination material is melted.

Meanwhile, when a temperature of the first laminated part where the lamination material is melted is higher than the heat treatment temperature, the induction heating coil may be not operated until the temperature of the first laminated part reaches the heat treatment temperature.

### Advantageous Effects

In accordance with the present invention, since a heat treatment process through induction heating is performed in real-time at the same time as lamination, a heat treatment process time can be reduced compared to before, thereby reducing the time required to produce a final product.

In accordance with the present invention, an object to be heated can be locally heated by adjusting the size and location of an induction heating coil and the frequency of AC power.

In accordance with the present invention, since coils can be manufactured to fit the size of a product, there is no product size limitation in a heat treatment process compared to the case of using a conventional heating furnace.

### DESCRIPTION OF DRAWINGS

FIG. 1 illustrates a method of forming a laminated structure according to an embodiment of the present invention.

FIG. 2 illustrates an operation process of a device for heat treatment using an induction heating coil according to a first embodiment of the present invention.

FIG. 3 illustrates steps of a heat treatment method using the induction heating coil according to the first embodiment of the present invention.

FIG. 4 illustrates a flowchart of the heat treatment method using the induction heating coil according to the first embodiment of the present invention.

FIG. 5 illustrates an operation process of a device for heat treatment using an induction heating coil according to a second embodiment of the present invention.

FIG. 6 illustrates a flowchart of a heat treatment method using an induction heating coil according to the second embodiment of the present invention.

FIG. 7 illustrates a device for heat treatment using an induction heating coil according to a third embodiment of the present invention.

### BEST MODE

Hereinafter, with reference to the attached drawings, a device for heat treatment using an induction heating coil and a method thereof according to a preferred embodiment will be described in detail as follows. Here, the same symbols are used for the same components, and repetitive descriptions and detailed descriptions of known functions and configurations that may unnecessarily obscure the gist of the invention are omitted. Embodiments of the invention are provided to more completely explain the present invention to those with average knowledge in the art. Therefore, the shapes and sizes of elements in the drawings may be exaggerated for clearer explanation.

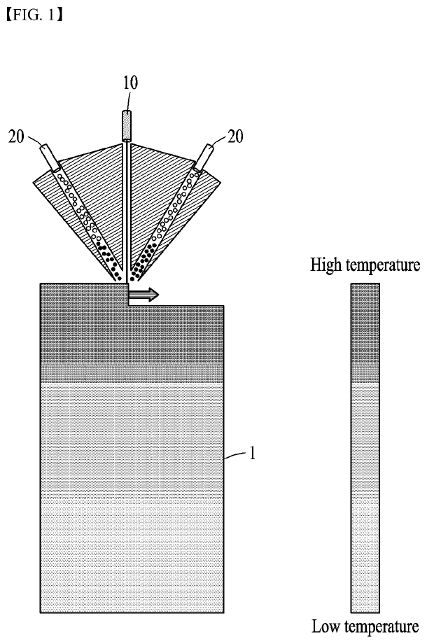

FIG. 1 illustrates a method of forming a laminated structure according to an embodiment of the present invention.

The present invention may be applied to various embodiments in which a laminated structure can be formed, such as welding and 3D printing. However, this specification focuses on a laminated structure manufactured by Directed Energy Deposition (DED), which is one of additive manufacturing methods, as an embodiment.

As shown in FIG. 1, The DED method is a method of supplying a metal powder lamination material to a lamination section in real-time in a protective gas atmosphere while simultaneously melting and laminating the lamination material with high energy using a high-power laser. Here, there is no limitation on the type of laminated material.

In this specification, an area where energy such as a laser is supplied is called an irradiator 100, and an area where a lamination material is supplied is called a supplier 200. A laminated structure that is being laminated or has been finished in the above-described manner is called a to-be-heated object.

Examining the lamination process, a lamination material and heat are supplied from an irradiator 10 and a supplier 20 and move in a horizontal direction of a to-be-heated object while melting, thereby forming one layer. When a layer of a certain length is formed, the lamination material and heat move in a vertical direction (toward a next layer) of the to-be-heated object. Here, the moving direction of the irradiator 10 and the supplier 20 is called a lamination direction. According to another embodiment, the irradiator 10 and the supplier 20 may stop, and a to-be-heated object may move in the lamination direction.

Meanwhile, a laminated structure manufactured by the above-described DED method is subjected to a heat treatment process to obtain the mechanical properties desired by a user, i.e., to reduce the residual stress inside a to-be-heated object or to change the internal structure thereof. Conventionally, heat treatment was performed after all of the laminated structures of a to-be-heated object were formed. Specifically, referring to FIG. 1, cooling begins from a part, where lamination has been completed first, of the to-be-heated object. Accordingly, in the to-be-heated object, the temperature of the bottom is the lowest and the temperature increases as the height increases. Here, although heat treatment is required for the previously cooled part of the to-be-heated object, heat treatment was not performed until all of the laminated structures were formed.

In a general heat treatment process, heat treatment control such as heating or cooling a to-be-heated object in a certain temperature range or maintaining it at a certain temperature is performed. This varies depending on the type of lamination material, and a specific heat treatment process is a known technology, so a detailed description is omitted.

Previously, heat treatment was performed by placing a completed to-be-heated object into a heating furnace, but there was a problem in that heat treatment took a long time due to a low heating rate (° C./min).

The present invention is intended to prevent these problems and relates to a device and method for a heat treatment process that can thermally treat a laminated area in real-time while a laminated structure is being formed.

### First Embodiment

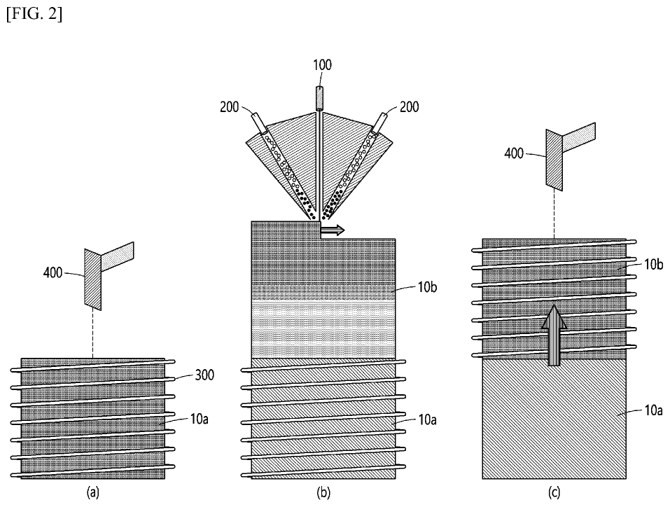

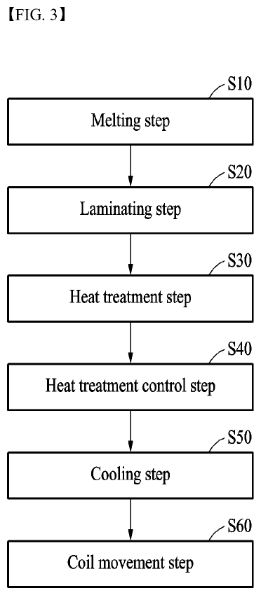

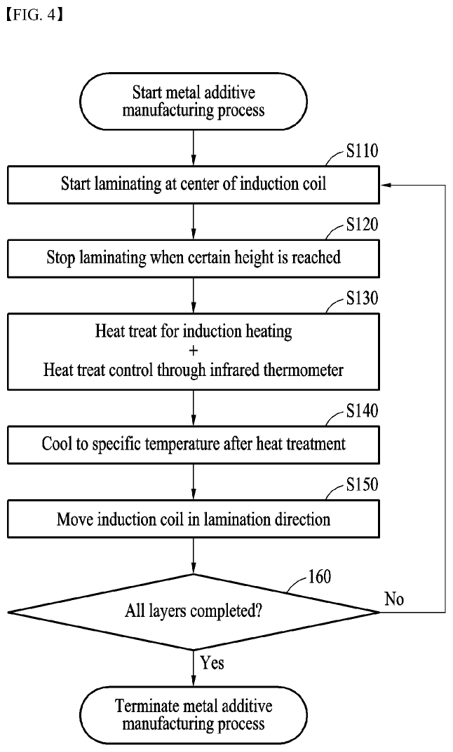

FIG. 2 illustrates an operation process of a device for heat treatment using an induction heating coil according to a first embodiment of the present invention, FIG. 3 illustrates steps of a heat treatment method using the induction heating coil according to the first embodiment of the present invention, and FIG. 4 illustrates a flowchart of the heat treatment method using the induction heating coil according to the first embodiment of the present invention.

As shown in FIG. 2, the device for heat treatment using the induction heating coil according to an embodiment of the present invention includes an irradiator 100, a supplier 200, an induction heating coil 300, a thermometer 400 and a controller (not shown). The irradiator 100 and the supplier 200 have the same functions as those of an irradiator and supplier of an existing lamination device.

The induction heating coil 300 is provided to supply heat necessary for heat treatment to a to-be-heated object. To briefly explain the principle by which the induction heating coil 300 transfers heat to a to-be-heated object, a magnetic field is generated by electromagnetic induction in the induction heating coil 300 due to power supply, and an induced current flows through the to-be-heated object located within this magnetic field, generating heat due to eddy current loss. This phenomenon is called induction heating. The induction heating action by the induction heating coil 300 is a known technology, so a detailed description thereof is omitted. Here, adjusting the alternating current power frequency allows localized heat treatment of a to-be-heated object, and a heat treatment process time may be reduced depending on the power intensity.

Meanwhile, if a to-be-heated object is located within the magnetic field formed by the induction heating coil 300, there are no restrictions on the shape and formation location of the induction heating coil 300. Some embodiments of the induction heating coil 300 are described below.

As described above, there is a temperature range required for a heat treatment process. In this specification, the temperature range is called heat treatment temperature. The heat treatment temperature may be a temperature range required for a specific heat treatment process. In addition, a heat treatment process may require maintaining the heat treatment temperature for a certain time.

As shown in FIG. 2, the induction heating coil 300 according to an embodiment of the present invention is constituted of a shape surrounding a to-be-heated object. Specifically, the diameter of the induction heating coil 300 is larger than the width of the to-be-heated object, and the height of the induction heating coil 300 has a certain preset height.

The thermometer 400 is provided to measure the temperature of a laminated part of the to-be-heated object in real-time. If the temperature of a laminated part can be measured, any thermometer can be used as a thermometer of the present invention regardless of whether it is a contact-type thermometer, such as a thermocouple, or a non-contact-type thermometer. In one embodiment of the present invention, an infrared thermometer capable of measuring temperature without contact with a to-be-heated object is used. As described above, a laminated part continues to change along a lamination direction, so a direction in which the thermometer 400 faces the laminated part may also change. For example, the thermometer 400 may be rotatably formed to face a laminated part at a specific position or to be movable along a laminated part.

The controller receives measurement information from the thermometer 400, determines whether a laminated part of a to-be-heated object satisfies the heat treatment temperature conditions, and controls the induction heating coil 300 to operate or the heat treatment temperature to be maintained for a certain time or the operation of the induction heating coil 300 to be turned off after a certain time. In addition, the controller controls the induction heating coil 300 to move in a lamination direction toward a next laminated part after the heat treatment for a previous laminated part is completed. In addition, the controller may also control power output to adjust a heat treatment temperature.

Hereinafter, an operation process of a device for heat treatment using an induction heating coil according to a first embodiment of the present invention and a method thereof are described with reference to FIGS. 2 to 4.

As shown in FIG. 3, the heat treatment method using an induction heating coil includes a melting step (S10) of melting the lamination material; a laminating step (S20) of laminating a to-be-heated object through the melting step; a heat treatment step (S30) of performing heat treatment in real-time using an induction heating coil when the temperature of a first laminated part of the to-be-heated object reaches a heat treatment temperature; a heat treatment control step (S40) in which, when the temperature of the first laminated part reaches the heat treatment temperature, the induction heating coil maintains the heat treatment temperature for a preset time and then operation thereof is stopped; a cooling step (S50) of cooling to a preset cooling temperature after heat treatment of the first laminated part is completed; and a coil movement step (S60) of moving the induction heating coil in a lamination direction to perform a heat treatment step for a second laminated part after the heat treatment of the first laminated part is completed.

Referring to FIG. 4, as a lamination material is melted by the irradiator 100 and the supplier 200, a to-be-heated object begins to be laminated (S110). Here, a laminated structure of the to-be-heated object is formed at the center of the induction heating coil 300 as described above. This corresponds to the melting step and the lamination step.

Next, when the to-be-heated object is laminated and reaches a certain preset height, the irradiator 100 and the supplier 200 stop operating and the laminating is stopped (S120). This is referred to as a first laminated part 10a. A position sensor (not shown) may be further provided to determine whether the height of the first laminated part 10a has reached a specific height. Here, the height of the first laminated part 10a formed may be the same as the formation height of the induction heating coil 300 described above, but is not necessarily limited thereto.

In general, a melting temperature by the irradiator 100 is high compared to a heat treatment temperature. Accordingly, Therefore, when a lamination material is molten, it needs to be cooled until it reaches the heat treatment temperature. For this, the thermometer 400 measures the temperature of the first laminated part 10a in real-time to determine whether the temperature of the first laminated part 10a has reached the heat treatment temperature. FIG. 2(a) illustrates a state of measuring using the thermometer 400 whether the temperature of the first laminated part 10a has reached the heat treatment temperature.

Next, When the temperature of the first laminated part 10a reaches the heat treatment temperature, a controller operates the induction heating coil 300 to control heat treatment to be performed on the first laminated part 10a (S130). In addition, the controller controls the heat treatment temperature to be maintained for a preset time. As described above, whether the laminated part cools and reaches the heat treatment temperature and whether the heat treatment temperature is maintained for a certain time may be determined by measuring in real-time with the thermometer 400. This corresponds to the heat treatment step and the heat treatment control step. FIG. 2(b) illustrates a state of the first laminated part 10a after heat treatment has been completed. Next, the controller controls the operation of the induction heating coil 300 to stop after a certain time.

Next, the controller controls the temperature of the first laminated part 10a, for which heat treatment has been completed, to be cooled to a preset cooling temperature (S140). This corresponds to the cooling step.

Next, the controller moves the induction heating coil 300 to a second laminated part 10b which is a next layer of the first laminated part 10a (S150). FIG. 2(c) illustrates the induction heating coil 300 moving in a lamination direction.

Here, the movement of the induction heating coil 300 is a relative movement in relation to the to-be-heated object. That is, the position of the to-be-heated object may be fixed and the induction heating coil 300 may move in the lamination direction by a separate lifting means, and the position of the induction heating coil 300 may be fixed and the position of the to-be-heated object may move in an opposite direction to the lamination direction.

Next, when the induction heating coil 300 is located at the second laminated part 10b, the controller determines whether the second laminated part 10b has reached the heat treatment temperature and repeats the heat treatment step, heat treatment control step and cooling step described above.

Next, the controller determines whether all layers are laminated (S160). If all layers have not been laminated, the above-described steps are repeated, and conversely, if all layers have been completed, the additive manufacturing process is terminated.

### Second Embodiment

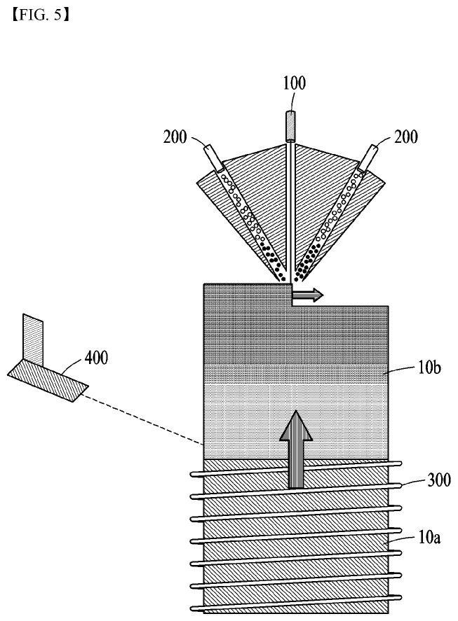

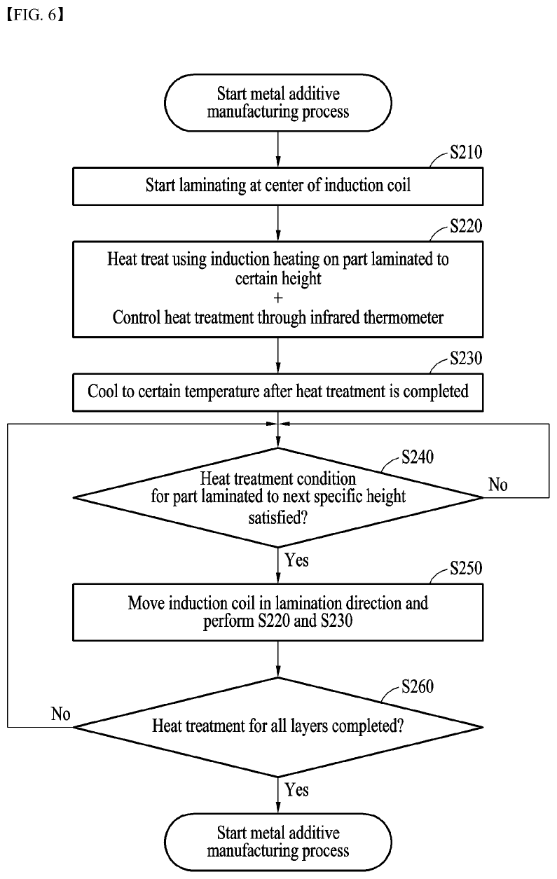

FIG. 5 illustrates an operation process of a device for heat treatment using an induction heating coil according to a second embodiment of the present invention, and FIG. 6 illustrates a flowchart of a heat treatment method using an induction heating coil according to the second embodiment of the present invention.

In the second embodiment, heat treatment is performed by the induction heating coil 300, which is the same as in the first embodiment. Accordingly, a description of the second embodiment will be focused on differences from the first embodiment.

Also in the second embodiment, the induction heating coil 300 is formed to surround a to-be-heated object. Lamination begins at the center of the induction heating coil 300 (S210). However, the lamination of the induction heating coil 300 is not stopped even if the first laminated part 10a is laminated to a certain height. That is, the first laminated part 10a is followed by the second laminated part 10b. Here, the controller performs a heat treatment process of the first laminated part 10a through the induction heating coil 300 (S220, S230, S240). Next, the controller determines whether the temperature of the second laminated part 10b has reached the heat treatment temperature after completing the heat treatment of the first laminated part 10a (S240). If the temperature of the second laminated part 10b has not reached the heat treatment temperature, the controller maintains the induction heating coil 300 in an off state until it reaches the heat treatment temperature, and conversely, if the temperature of the second laminated part 10b reaches the heat treatment temperature, the controller moves the induction heating coil 300 to the second laminated part 10b and performs S220, S230 and S240 (S250). Next, the controller determines whether all layers are laminated (S260). If all layers have not been laminated, the above-described steps are repeated, and conversely, if all layers have been completed, the additive manufacturing process is terminated.

As described above, unlike the first embodiment, the second embodiment does not include a lamination interruption process.

### Third Embodiment

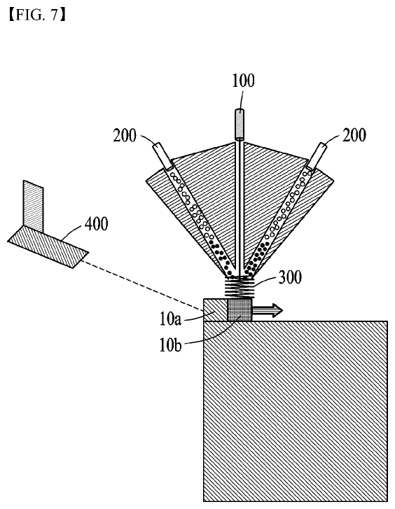

FIG. 7 illustrates a device for heat treatment using an induction heating coil according to a third embodiment of the present invention.

In the third embodiment, an induction heating coil 300 is located on one side of an irradiator 100. Accordingly, the induction heating coil 300 may move along a laminated part together with the irradiator 100. That is, according to the third embodiment, a heat treatment process by the induction heating coil 300 may be performed directly on a molten area by the irradiator 100.

As described above, the melting point of a lamination material is higher than the heat treatment temperature. Accordingly, a controller controls the operation of the irradiator 100 and the supplier 200 to stop after the first laminated part 10a is laminated. The controller determines whether the temperature of the first laminated part 10a has reached the heat treatment temperature through the thermometer 400. If the temperature of the first laminated part 10a has reached the heat treatment temperature, the controller controls the heat treatment process of the first laminated part 10a to be performed through the induction heating coil 300, and conversely, if the temperature of the first laminated part 10a has not reached the heat treatment temperature, the controller controls the induction heating coil 300 not to operate until the heat treatment temperature is reached. The above-described process is repeated until all layers are laminated.

Although the present invention has been described with reference to embodiments shown in the accompanying drawings, the embodiments are provided as only exemplary examples, and those skilled in the art will understand that various modifications and equivalent other embodiments are possible therefrom. Therefore, the true technical protection scope of the present invention should be determined by the technical spirit of the appended claims.

1. A device for heat treatment using an induction heating coil, the device comprising:
a supplier for supplying a lamination material;
an irradiator for applying heat to melt the lamination material;
an induction heating coil, operated at a preset heat treatment temperature, on a laminated part, which requires heat treatment, of a to-be-heated object in which the lamination material is melted and laminated; and
a controller configured to turn the induction heating coil on and off or to control the induction heating coil to move in a lamination direction of the to-be-heated object.

2. The device according to claim 1, further comprising a thermometer configured to determine whether the laminated part reaches the heat treatment temperature.

3. The device according to claim 2, wherein the thermometer is an infrared thermometer.

4. The device according to claim 1, wherein the induction heating coil maintains the heat treatment temperature for a preset time and then stops operating when a temperature of the laminated part reaches the heat treatment temperature.

5. The device according to claim 1, wherein the induction heating coil is formed to surround the to-be-heated object.

6. The device according to claim 5, wherein, when the to-be-heated object is laminated to a preset height, lamination is stopped for heat treatment.

7. The device according to claim 1, wherein the induction heating coil is formed on one side of the irradiator to face a laminated part melted by the irradiator.

8. A heat treatment method using an induction heating coil, the heat treatment method comprising:
a melting step of melting a lamination material;
a laminating step of laminating a to-be-heated object through the melting step;
a heat treatment step of performing heat treatment in real-time using an induction heating coil when a temperature of a first laminated part of the to-be-heated object reaches a heat treatment temperature; and
a coil movement step of moving the induction heating coil in a lamination direction to perform a heat treatment step of a second laminated part after the heat treatment of the first laminated part is completed.

9. The heat treatment method according to claim 8, further comprising a heat treatment control step in which, when a temperature of the first laminated part reaches the heat treatment temperature, the induction heating coil maintains the heat treatment temperature for a preset time and then operation thereof is stopped.

10. The heat treatment method according to claim 8, further comprising a cooling step of cooling to a preset cooling temperature after heat treatment of the first laminated part is completed.

11. The heat treatment method according to claim 18, wherein the induction heating coil is formed to surround the to-be-heated object.

12. The heat treatment method according to claim 8, wherein, in the laminating step, laminating is stopped when a height of the first laminated part reaches a preset height.

13. The heat treatment method according to claim 8, wherein the induction heating coil is formed to be movable along a laminated part where a lamination material is melted.

14. The heat treatment method according to claim 13, wherein, when a temperature of the first laminated part where the lamination material is melted is higher than the heat treatment temperature, the induction heating coil is not operated until the temperature of the first laminated part reaches the heat treatment temperature.
